(19) United States
(12) Patent Application Publication
(10) Pub. No.: US 2025/0210637 A1
(43) Pub. Date: Jun. 26, 2025

(54) FLAT SILICON ANODE ON A COPPER CONDUCTOR FOR LITHIUM ION BATTERIES

(71) Applicant: NORCSI GMBH, Halle (DE)

(72) Inventors: Udo REICHMANN, Wilsdruff (DE); Andreas KRAUSE-BADER, Dresden (DE); Marcel NEUBERT, Kreischa (DE)

(73) Assignee: NORCSI GMBH, Halle (DE)

(21) Appl. No.: 18/876,141

(22) PCT Filed: Feb. 8, 2023
(86) PCT No.: PCT/EP2023/053091

§ 371 Date: Dec. 17, 2024

(30) Foreign Application Priority Data
Jun. 20, 2022 (DE) 10 2022 115 232.4

(51) Int. Cl. H01M 4/38; H01M 4/02; H01M 4/134; H01M 4/36; H01M 4/66; H01M 10/0525

(52) U.S. Cl. CPC H01M 4/386; H01M 4/134; H01M 4/364; H01M 4/661; H01M 10/0525; H01M 2004/021; H01M 2004/027

(57) ABSTRACT

The invention relates to a silicon electrode suitable for use as an anode in a lithium ion battery, comprising a current collector, preferably made of copper, an adhesive layer arranged on the current collector, and a multi-layer structure arranged on the adhesive layer. The object of providing an Si electrode, which is not pulverised when lithium is incorporated and therefore does not lose the electrical contact with the current collector as a result, as well as having a stable surface and high intrinsic conductivity, is achieved in that the multi-layer structure, as an active layer of the Si electrode, is formed by at least one layer made of a metal and silicon or formed by a mixed system consisting of silicon mixed with at least one metal, wherein the multi-layer structure undergoes rapid tempering and forms a conductive metal silicide matrix, wherein the metal silicide matrix contains amorphous, nanocrystalline regions of the silicon.

The invention relates to a silicon electrode suitable for use as anode in a lithium-ion battery, comprising a current collector, preferably composed of copper, an adhesion layer arranged on the current collector, and a multistratum structure arranged on the adhesion layer.

The invention further relates to a battery cell comprising the silicon electrode according to the invention and to a battery comprising at least one battery cell.

Electrochemical energy storage is a key pillar of a global energy revolution for temporary storage of fluctuating renewable power and provision of said power for stationary and mobile applications. The rapid development in the field of electromobility and in mobile communication devices is also increasing the demand for high storage capacities and high charge rates for energy storage devices. This is where established technologies reach their limits. To counteract a raw material-related shortage and hence an increase in the costs of especially secondary batteries, what are needed are not only diversification of energy storage concepts, but also novel materials. They should, firstly, improve the technical performance of relevant energy storage concepts (including capacity, energy density, service life) and, secondly, minimize production costs. The latter can be ensured, in particular, by using readily available chemical elements, such as silicon, for which a broad technological base already exists.

Batteries are electrochemical energy storage devices and a distinction is made between primary and secondary batteries.

Primary batteries are electrochemical power sources in which chemical energy is irreversibly converted into electrical energy. A primary battery is thus not rechargeable. Secondary batteries, also termed accumulators, are on the other hand rechargeable electrochemical energy storage devices in which the chemical reaction that occurs is reversible, which means that repeated use is possible. Electrical energy is converted into chemical energy when charging and in turn from chemical to electrical energy when discharging.

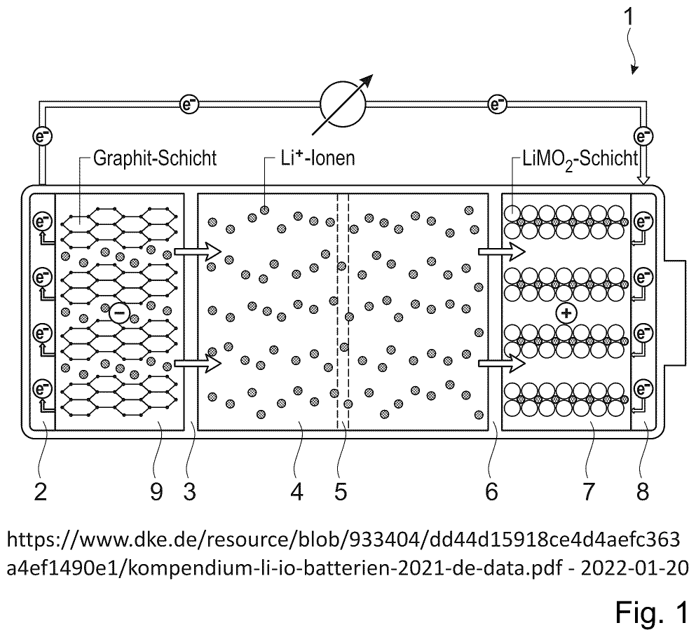

Battery is the generic term for an array of cells connected together. Cells are galvanic units that consist of two electrodes, electrolyte, separator, and cell housing. FIG. 1 shows an exemplary structure and the function of a lithium-ion cell during the discharge process.

The components of a cell are explained in brief hereinbelow.

Each Li-ion cell consists of two different electrodes 7, 9, an electrode 7 that in the charged state is negatively charged and an electrode 9 that in the charged state is positively charged. During energy release, i.e. during discharge, ions migrate from the negatively charged electrode to the positively charged electrode, and so the positively charged electrode is termed the cathode 7 and the negatively charged electrode the anode 9. The electrodes are each composed of a current conductor 2, 8 (also termed a collector) and an active material applied thereon. Between the electrodes are, firstly, the ion-conducting electrolyte 4, which permits the necessary charge exchange, and the separator 5, which ensures the electrical separation of the electrodes.

The cathode consists for example of mixed oxides applied on an aluminum collector. Transition metal oxides with cobalt (Co), manganese (Mn) and nickel (Ni) or aluminum oxide (Al₂O₃) are the most common compounds. The applied metal oxide layer serves for intercalation of the lithium ions when the cell is discharging.

The anode of the Li-ion cell can consist of a copper foil as collector and a layer of carbon as active material. The carbon material used is generally natural or artificial graphite because it has a low electrode potential and has low volume expansion during the charge and discharge process. During the charge process, lithium ions are reduced and intercalated into the graphite layers.

In structures for lithium-ion batteries, the cathode typically supplies the lithium atoms for charging and discharging in the anode, and so the battery capacity is limited by the cathode capacity. As already mentioned, examples of typical cathode materials used up to now are Li(Ni,Co,Mn)O₂ and LiFePO₄. Since the structure of the cathode is based on lithium metal oxides, an increase in capacity is only possible to an insignificant extent.

It is also known to use silicon instead of carbon in Li battery anodes. Silicon is a semiconductor of poor conductivity, very hard and brittle, and the surface reacts with oxygen to form silicon dioxide. However, silicon as anode material has a high storage capacity of 3579 mAh/g at room temperature compared to the conventional carbonaceous materials, such as graphite with a storage capacity of 372 mAh/g. With respect to pure metallic lithium, silicon has a distinctly reduced reactivity and prevents the formation of dendritic structures, especially at high surface currents. Dendrites are tree-or bush-like crystal structures that can push through the separator, the result being short-circuiting of the battery and hence rapid cell death. However, challenges that arise when using silicon as an anode material include the sometimes considerable change in volume (volume contraction and expansion) of the host matrix during the intercalation and deintercalation of the mobile ion species during charging and discharging of corresponding energy storage devices. In the case of intercalation of lithium, the alloying with lithium to form Li₁₅Si₄ results in a volume expansion of up to 400%. The change in volume for graphite is approx. 10%. The change in volume of the anode material when using silicon leads to internal stresses, cracking, pulverization of the active material of the host matrix (silicon) and eventually complete destruction of the anode. The brittle Si layer crumbles and loses electrical contact with the conductive current collector, and the result is loss of active material. At the same time, there is steady breakup of the surface of the Si anode, which causes a continuous buildup of a solid electrolyte interphase (SEI) with simultaneous breakdown of the electrolyte.

To date, nanostructures of up to 100 nm for crystalline silicon and of up to 1 μm for amorphous silicon have been considered to be suitable for homogeneous volume expansion. This allows compensation for the stress of volume expansion without the surface breaking up. Nevertheless, this thickness is by far insufficient to compete with the storage capacity of current lithium-ion batteries; this requires structures of at least 5 μm pure silicon, which corresponds to an ideal capacity of 3.5 mAh/cm².

The focus of previous research in the field of lithium-ion batteries has been on the development of silicon nanostructures to prevent pulverization of the silicon used, focusing on ensuring continuous electrical contact with the current collector during volume expansion in battery operation. It is known that only the use of nanowires was possible for pure silicon. For powder-or particle-based silicon, an appropriately conductive adhesive or binder is required to ensure electrical contact. Silicon powders are currently provided with binders and applied to the current collector in a slurry process. The silicon volume expansion that occurs nevertheless on lithium intercalation has so far limited use thereof to less than 20% by volume of silicon in the slurrys. Slurrys are understood to mean mixtures of solid substances in which the solids are dispersed in a liquid. In the slurry-based processes, a layer of silicon particles is applied to or calendered onto a current collector with a carbonaceous binder. The binder ensures adhesion and electrical contact between the particles and with the current collector. Immense effort has previously been made to produce macroscopic amounts of silicon having nanoporous structures. The conductivity of the structures is limited to the conductivity of the binders. The porous structures have a large surface area and thus tend to form an immense solid electrolyte interface (SEI).

The silicon-based anodes developed to date have, in summary, the following problems: high volume expansion on intercalation of lithium, an associated pulverization of the material and loss of electrical contact with the current collector, an unstable anode surface, and a poor intrinsic conductivity.

It is therefore an object of the present invention to specify a silicon electrode which is suitable for use as anode in a lithium-ion battery and which does not have the problems summarized above.

The object is achieved by a silicon electrode as claimed in independent claim 1.

The silicon electrode according to the invention that is designed and intended for use as anode in a lithium-ion battery comprises a current collector, preferably composed of copper, an adhesion layer arranged on the current collector, and a multistratum structure arranged on the adhesion layer, wherein the multistratum structure as active layer of the Si electrode is formed from at least one stratum composed of a metal and silicon or is formed from a mixed system consisting of silicon admixed with at least one metal, the multistratum structure being subjected to rapid thermal annealing and forming a conductive metal silicide matrix, the metal silicide matrix enclosing amorphous, nanocrystalline regions of silicon.

The adhesion layer in one configuration of the Si electrode according to the invention is formed from one or more of the materials titanium (Ti), silicon (Si), chromium (Cr), tantalum (Ta) and/or tungsten (W).

The adhesion layer guarantees an extremely stable contact between the active layer of the anode and the current collector of the anode, due to, firstly, mechanical fixation by means of a roughened surface and, secondly, (partial) reaction with the substrate (chemisorption). Usable or employable adhesion layers consist of titanium or chromium as adhesion promoter; with suitable diffusion barriers such as tungsten or carbon, silicon itself can also be used/employed as adhesion layer.

The rapid thermal annealing with a controllable and defined input of energy into a silicon stratum of the multistratum structure brings about partial reaction of the silicon with the copper current collector and the formation of a roughened surface, thereby establishing extremely strong adhesion between the multistratum structure and the current collector that does not weaken during battery operation.

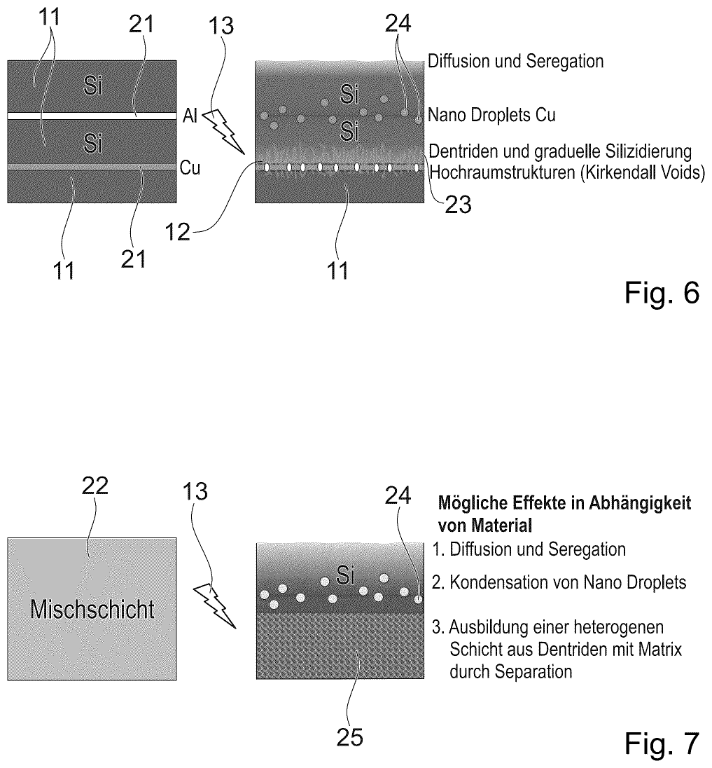

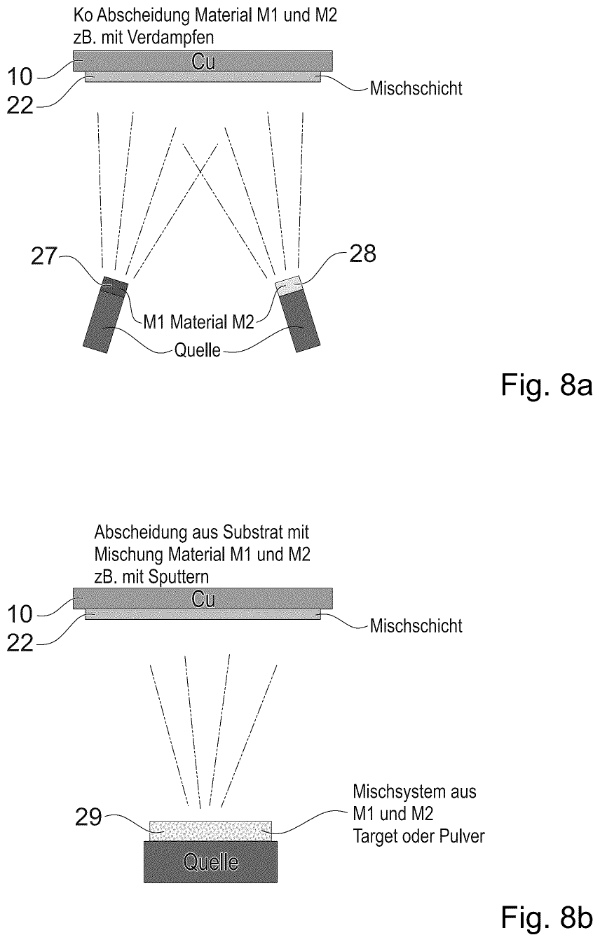

The multistratum structure as active layer of the Si electrode is formed from at least one stratum. One stratum comprises a deposited layer of active material, capable of lithium intercalation, and one or more layers of metal. Depending on the target capacity, the stratum thickness of the active layer, i.e. the composite of active material and metal, of the electrode may be composed of one or more strata. As one alternative, the at least one stratum may be formed from at least one metal and silicon. The silicon and the at least one metal are applied by deposition of separate layers of the materials in an alternating manner. One stratum is thus formed from at least one layer of at least one metal and one layer of silicon, and the target thickness of the anode is achieved by forming multiple strata in the multistratum structure (FIG. 5). As another alternative, the at least one stratum may be formed by a mixed system, with the mixed system of silicon having been admixed with at least one metal (FIG. 6). This homogeneous mixture of at least one metal and silicon can be produced from a sputtering target of sintered powder (FIG. 8b) or it is deposited by codeposition (FIG. 8a) of the starting materials to form a mixed layer. The layer thickness for silicon is between 500-1000 nm, and for metal the layer thickness is between 10-100 nm. This means that a multistratum structure of the active layer having a total thickness of 5 μm can consist of up to 20 individual strata.

Volume expansion does occur on lithium intercalation, but there is no pulverization of the silicon layer owing to the admixing of metals and the use of the multistratum structure. The admixing of metals leads to alloy formation with reduced hardness compared to pure silicon. At the same time, very high electrical conductivity of the silicon is produced compared to graphite. Despite the admixing of metals, a specific total capacity of over 2000 mAh/g is guaranteed.

The stability and high electrical conductivity of the silicon electrode according to the invention is supported by the formation of a heterogeneous structure with formation of a conductive matrix of metals or metal silicides which encase the amorphous regions of silicon.

In one configuration of the silicon electrode according to the invention, on the multistratum structure is arranged a further layer composed of silicon or the mixed system and/or a protective layer that forms a planar surface.

The deposition technology used for the multistratum structure, for example sputtering, results in the formation of a planar surface. What may be arranged thereon in turn is a layer composed of silicon or the mixed system of silicon and one or more metals up to a desired layer thickness and/or a protective layer. The planar stratum structure has only a small surface area which does not change during battery operation. This limits the buildup of an SEI and the loss of electrolyte to an absolute minimum.

In a further configuration of the silicon electrode according to the invention, on the planar multistratum structure is therefore arranged a boundary layer and/or a solid electrolyte.

The planar stratum structure of the multistratum structure simultaneously offers the possibility of mounting of an artificial protective layer (artificial SEI) through to application of a solid electrolyte for battery optimization and is therefore suitable for novel cell concepts.

In another configuration of the silicon electrode according to the invention, the multistratum structure has an active layer thickness of 10 μm.

In a further other configuration of the silicon electrode according to the invention, the multistratum structure has a specific capacity of >1500 mAh/g, preferably >2000 mAh/g.

Thus the active layer in the multistratum construction or in the multistratum structure—both terms are used synonymously—comprising various materials and the silicon or in the manner of a mixed system of silicon and one or more metals makes it possible to establish a specific capacity of over 1500 mAh/g, preferably over 2000 mAh/g. In relation to the specific capacity of pure silicon of 3579 mAh/g, the capacity of the Si electrode according to the invention reaches more than 50%.

In one configuration of the silicon electrode according to the invention, the multistratum structure has an areal capacity of 2 mAh/cm² to 6 mAh/cm². Larger areal capacities are not practical, since production becomes increasingly costly and inconvenient with increasing layer thickness.

In one configuration of the silicon electrode according to the invention, the multistratum structure is producible by deposition of separate strata of the silicon and of the at least one metal in an alternating manner into multistrata.

The advantage of a stratum structure over a mixed system is that it is possible to vary each layer in each stratum and thus create a tailored structure having advantageous properties. For example, volume expansion can be controlled by creating a graduated structure in which an increased metal silicide fraction is incorporated in the near-substrate region, whereas a silicon-rich structure can be chosen in the near-surface region.

In another configuration of the silicon electrode according to the invention, the metal provided in the active layer is formed from at least one of the materials titanium (Ti), nickel (Ni), iron (Fe), manganese (Mn), aluminum (Al), tin (Sn), gold (Au) and/or silver (Ag) and/or a mixture of said materials.

In a further configuration of the silicon electrode according to the invention, the rapid thermal annealing is a flash lamp annealing, the flash lamp annealing being performable by means of a flash lamp with a flash time in the range from 0.2 to 20 ms and an energy density in the range from 0.3 to 160 J/cm² and/or preheating or cooling in the range from 4° C. to 200° C.

In another further configuration of the silicon electrode according to the invention, the rapid thermal annealing is a laser annealing, the laser annealing being performable by means of a laser with an annealing time in the range from 0.01 to 100 ms through the setting of a scan speed of a local heating point and an energy density in the range from 0.1 to 100 J/cm² and/or with preheating or cooling in the range from 4° C. to 200° C.

The temperature range from 4° C. to 200° C. indicated is the surface temperature of the substrate or of the layer to be annealed.

It has been found that there is variation in the effect of rapid thermal annealing in the deposition of different materials in the active layer. The reason for this is the wide variety of chemical processes in connection with silicon. As a result, other structures may form in the anode layer produced, for example column structures in the case of nickel. Furthermore, what may form are other silicides which also intercalate lithium, in contrast to Cu silicides which can intercalate insignificantly little to no lithium. The advantage of exploiting the aforementioned differences is that this allows control of the volume expansion of silicon on lithium intercalation. As a result, the stability of battery operation is distinctly increased.

In the case of titanium, what is formed is Ti silicide, which may be capable of Li intercalation in the correct phase (see: Xu, J. et al. Preparation of TiSi₂ Powders with

Enhanced Lithium-Ion Storage via Chemical Oven Self-Propagating High-Temperature Synthesis. Nanomaterials 11, 2279 (2021)). This has the advantage that there is no clear Li-active-inactive interface and thus a good electrical contact even during cycling. Other metals such as aluminum do not form a compound with silicon, i.e. they do not form silicides. The consequence of this is that these metals mix in silicon and electrical conductivity is increased. In the rapid thermal annealing step, the morphology and hardness of the silicon-metal layer can additionally be improved compared to the hard pure silicon.

The reactions between the silicon particles and the metal particles that are forced by rapid thermal annealing are nonequilibrium processes which are only realizable in the ms range and therefore necessitate the use of a flash lamp or a laser.

The heating ramps achieved in rapid thermal annealing are within the range of 10⁴-10⁷ K/s that is necessary in the process. Flash lamp annealing employs for this purpose a spectrum in the visible wavelength range, whereas laser annealing uses discrete wavelengths in the infrared (IR) to ultraviolet (UV) spectrum.

The aforementioned reaction is made possible by the defined input of energy by means of rapid thermal annealing into one or more strata of particles. What occurs is a sufficient reaction between metal and silicon without the silicon reacting completely or only insufficient active material remaining. More metal means more reaction opportunities, but less active material. More energy means more adhesion, but less active material. An optimal result depends on the materials and particle sizes used.

The invention will now be more particularly elucidated using exemplary embodiments. The drawings show

FIG. 1 Exemplary structure and function of a lithium-ion cell during the discharge process;

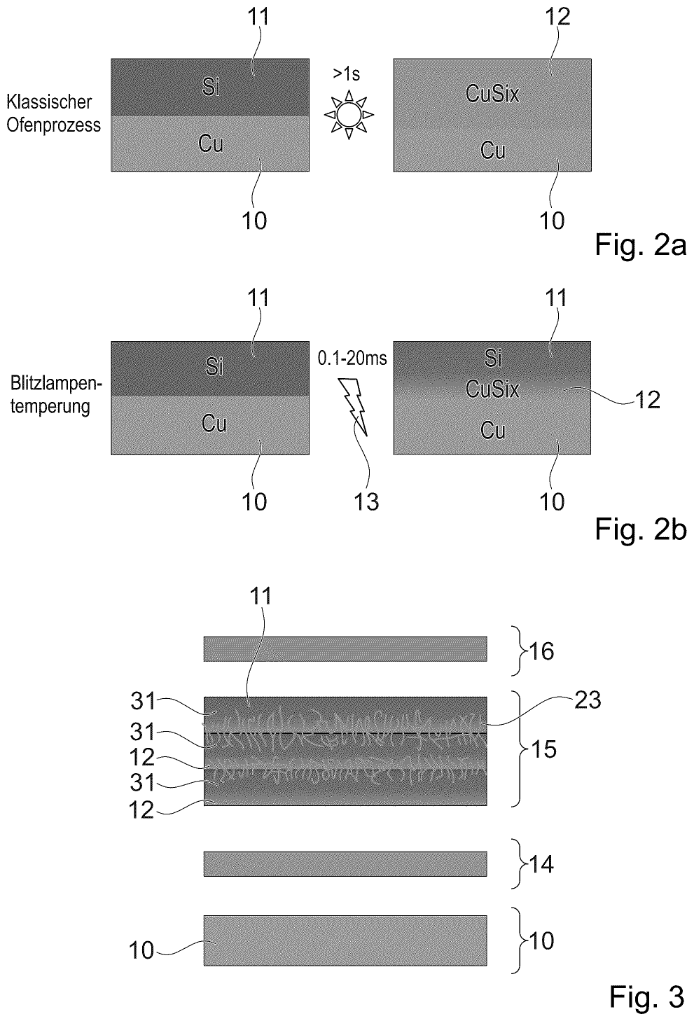

FIG. 2 Influence of a temperature input on silicide formation in a silicon anode a) in a classic furnace process (prior art) b) with rapid thermal annealing, in particular flash lamp annealing;

FIG. 3 Schematic illustration of the planar Si anode according to the invention;

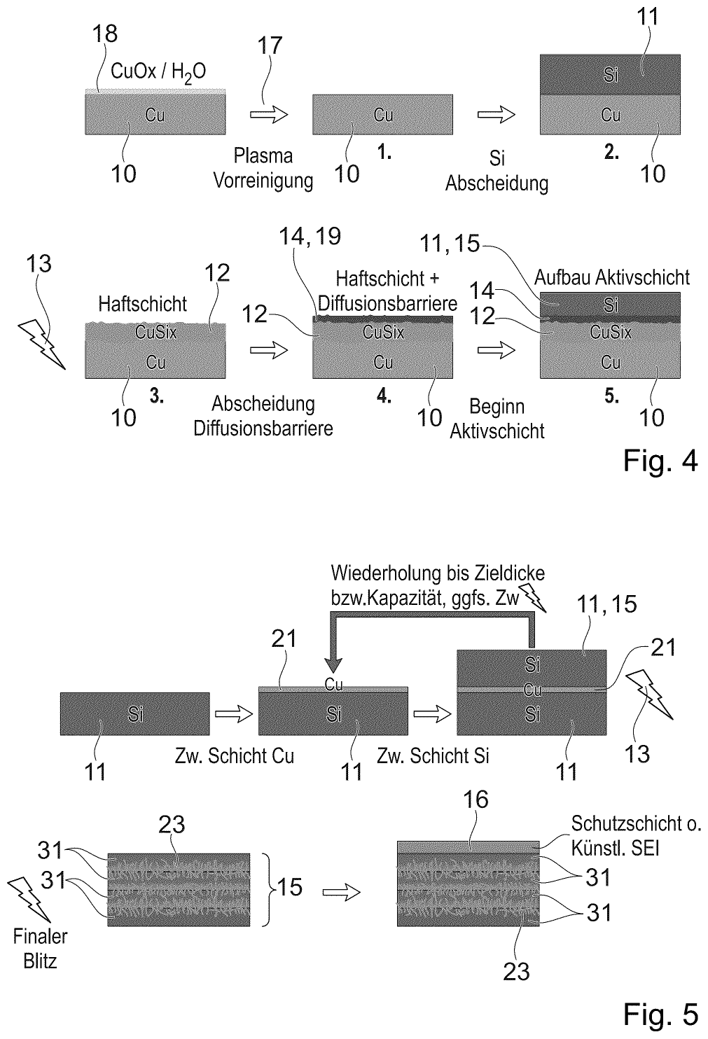

FIG. 4 Schematic illustration of the process for producing an adhesion layer composed of silicon;

FIG. 5 Schematic illustration of a process for producing a multistratum structure composed of silicon and metal;

FIG. 6 Schematic illustration of a heterogeneous multistratum structure according to one variant of the Si electrode according to the invention;

FIG. 7 Schematic illustration of a multistratum structure formed from a mixed system according to a further variant of the Si electrode according to the invention;

FIG. 8 Possible production variants of the Si electrode according to the invention a) codeposition of various materials, b) deposition of a mixed target;

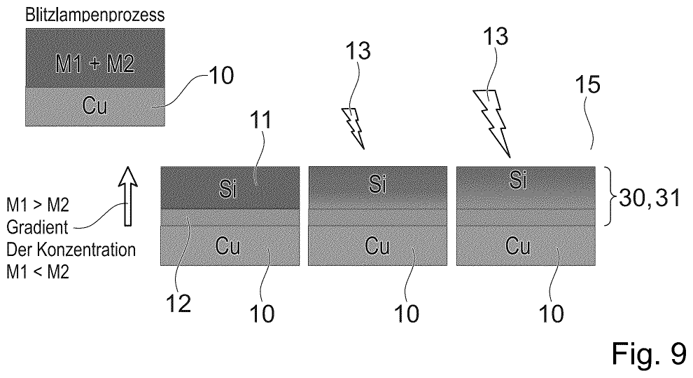

FIG. 9 Schematic illustration of a process for producing a mixed system having gradients.

The diffusion of metals in silicon and the reaction of silicon with metals is highly time-dependent and temperature-dependent. At just low temperatures above 200° C., what is formed with many metals at the boundary contact between metal and silicon is a metal silicide which is capable of reversible intercalation of lithium, is not capable of it, or is only capable of it to a very slight extent. Metals already diffuse at room temperature and diffuse very rapidly at elevated temperature, the diffusion being difficult to control in classic furnace processes. Using the example of copper, a complete layer of silicon has reacted through after at least 1 s at 600° C. (see FIG. 2a).

FIG. 2b) shows the influence of rapid thermal annealing 13, in particular flash lamp annealing, on silicide formation 12 at the contact point in a layer system of copper 10 and silicon 11. Because of the very short flash pulse in the range from 0.1 to 10 ms, the silicon 11 does not react completely with the copper 10 to form copper silicide 12. The flash lamp annealing 13 results in the persistence of pure amorphous or nanocrystalline silicon 11, which is available as active material for lithium intercalation, with at the same time a sufficient number of inactive regions, which ensure stability and good electrical conductivity.

FIG. 3 shows the schematic illustration of the planar Si anode according to the invention. Arranged on a copper substrate 10 is an adhesion layer 14, applied on which is the multistratum structure 15 as active layer of the Si anode. Formed thereon, lastly, is a protective layer 16 or artificial SEI.

FIG. 4 shows process steps for producing an adhesion layer 14 on the copper substrate 10 for the subsequent mounting of the active layer 15 of the Si anode. A substrate 10, which simultaneously serves as current collector in an LIB (lithium-ion batteries), undergoes precleaning 17 under vacuum conditions in a plasma atmosphere. This cleaning is necessary because of the formation of an oxidation layer 18 on the substrate 10 in air that would prevent a reaction between a subsequently applied silicon layer 11 and the copper substrate 10 during flash lamp annealing 13 (FLA), meaning that the silicon layer 11 would not adhere to the Cu substrate 10. Subsequently, a first silicon layer 11 is deposited, for example by means of sputtering. Said first silicon layer 11 reacts with the Cu substrate 10 in a transition region to form copper silicide 12, as a result of which the roughness of the substrate 10, for example a Cu foil, is increased and the silicon layer reacted with the copper serves as a kind of bonding layer for the mounting of further strata. The copper silicide layer 12 is completely inactive in a battery, and so in a subsequent step a diffusion barrier 19, for example composed of carbon, is first applied. Said diffusion barrier 19 is necessary to prevent the reaction of silicon 11 in copper 10 to form copper silicide 12 during further rapid thermal annealing 13. Subsequently, further Si layers 11, 31 can then be applied sequentially, and the strata can be stabilized by flash lamp annealing 13 (FIG. 5). The advantage of repeated Si deposition and subsequent flash lamp annealing 13 is the formation with each sequence of a stable (“reacted”) layer with a completed interface which acts as interlayer (interface) for the subsequent strata. This is advantageous for the adhesion of the Si layer on copper foil, since copper silicide 12 is partially formed and active silicon 11 is available nevertheless. The described process according to the invention therefore additionally brings about roughening of the surface, thus producing good adhesion for further layers. The growth of column structures is also promoted, thus allowing achievement of better ion conductivity and good control of copper content for subsequent processes. Lastly, a protective layer 16 is applied to the multistratum structure 15.

By repeated deposition of silicon 11, metal 21 and subsequent rapid thermal annealing 13, in particular flash lamp annealing, it is therefore possible to control the diffusion and silicide formation 30 in one layer, and so it is possible to establish a gradient of silicide formation perpendicular to the surface.

The gradient of copper silicide formation 12, 30 can be established by setting of the flash lamp energy, the flash lamp time or the annealing time through the setting of a scan speed of a local heating point and an energy density by means of a laser and/or by adjustment of the minimum thickness of the deposited silicon layer 11.

FIG. 6 shows a schematic illustration of a heterogeneous structure of a multistratum construction 15 formed from strata formed from silicon 11 and one or more metals 21. As a result of the rapid thermal annealing 13, what are formed in the strata owing to diffusion and segregation processes are dendrites 23 and nanoparticles 24, which form a silicide matrix having large proportions of amorphous silicon 11 which, as high-capacity electrode material, is ideally suited to cushioning the volume expansion of silicon due to lithium intercalation. At the same time, the conductive silicide matrix forms a stable scaffold of dendrites 23 to ensure a solid electrical contact with the current collector and thus allow continuous battery operation. Void structures are able to form because the rate of diffusion of Cu in Si is much higher than that of Si in Cu: D_{Cu in Si}>>D_{Si in Cu}. In a state of thermal equilibrium, the following approximation applies: D_{Cu in Si}≈D_{voids}+D_{Si in Cu}.

FIG. 7 shows the influence of rapid thermal cycling 13 on a mixed system 22. Depending on the material used for the active layer 15 of the Si anode, separation processes can result in the uniform formation of a heterogeneous layer 25 composed of a scaffold of conductive dendrites 23 with an amorphous matrix of the active material 11. Owing to oversaturation, nanoparticles (nanodroplets) 24 can also form by condensation through the partial separation of the starting materials.

FIG. 8 shows two variants for producing the planar Si anode according to the invention. A mixed layer 22 composed of at least one metal and silicon can be produced from a sputtering target of sintered powder (FIG. 8b) or the mixed layer 22 is produced by codeposition (FIG. 8a) of the starting materials M1 27 and M2 28 from two sources to form a mixed layer 22, for example by means of evaporation, up to the target thickness of the active layer 15.

FIG. 9 shows the way of producing a layer gradient in a deposited multistratum construction composed of partially reacted layers/strata 30. The gradient of silicide/silicon concentration 12, 11 in the multistratum structure 15 can be established, firstly, by the chosen process parameters of the rapid thermal annealing process 13 and, secondly, by the thickness of the deposited metal layers or the ratio between Si 11 and metal 21 in a deposited stratum 31. The higher the energy input chosen, for example by flash lamp or laser 13, the greater the amount of metal atoms that can diffuse into the silicon layer 11 during the rapid thermal annealing process, i.e. the lower the gradient of silicide/silicon concentration in the stratum (cf. FIG. 9, subpicture on the right). A low gradient is equivalent to the concentration of silicide in a stratum 31 or in the active layer 15 of the anode decreasing gradually from the side of the stratum/active layer 31 facing the current collector 10 to the side of the stratum/active layer facing away from the current collector. A high gradient means a rapid decrease in the silicide concentration. A high concentration of silicide is formed on the bottom of the stratum 31 and this decreases rapidly, with only silicon 11 being present on the top, i.e. on the side of the stratum/active layer 31 facing away from the current collector 10. The pure silicon 11 is available for the intercalation of lithium, whereas the silicide formation 12 increases electrical conductivity.

The gradient of, for example, copper concentration in a silicon layer with a copper layer is established by adjustment of the pulse time, of the preheating or cooling of the stratum structure and of a layer thickness of the deposited strata, i.e. by adjustment of the energy input (in terms of time and temperature) and the thickness ratio of silicon layer to copper layer, with the aim of the mean reaction depth (diffusion length) being smaller than the layer thickness of the silicon layer in order to provide sufficient unreacted silicon for the intercalation of lithium.

The silicon electrode according to the invention as anode in a lithium-ion battery therefore has the following overall structure:

Present on a copper current collector 10 (conductor) is partially reacted Si 30 with Cu as adhesion layer 14, on which the active layer in the multistratum construction 15 comprising various materials (metals and silicon) or in the form of a mixed system 22 of at least one metal and silicon has been deposited and has a specific capacity above 1500 mAh/g, preferably greater than 2000 mAh/g. Deposited on said multistratum structure 15 is a further layer composed of silicon or the mixed system and/or a protective layer or, as desired, a boundary layer through to mounting of a solid electrolyte, which layer has a planar surface. This structure realizes an active layer thickness of the active material of the anode of 10 μm, which allows an areal capacity of 4 mAh/cm² at a specific total capacity of 2000 mAh/g. This layer structure allows excellent lithium diffusion and high electrical conductivity and is suitable for battery operation without pulverization of the active layer 15.

Further advantages of the anode according to the invention are the high charge rates of more than 1 C without any relevant loss of capacity. Owing to the heterogeneous formation of a silicide scaffold, the active layer 15 of the anode has an electrical conductivity of up to 5*10⁴ S/cm that is increased up to 100 times compared to graphite. The low resistance means that less waste heat is produced during charging/discharging, and a more compact design of the entire cell with less cooling is possible.

Owing to the planar surface, the buildup of an SEI is limited to an absolute minimum, and only the tiniest quantities of additives for SEI control are required. This also results in low electrolyte consumption and a high longevity of anodes constructed in this manner.

### LIST OF REFERENCE SIGNS

1 Lithium-ion battery
2 Collector on anode side
3 SEI (solid electrolyte interphase)
4 Electrolyte
5 Separator
6 Conductive intermediate phase
7 Cathode, positive electrode
8 Collector on cathode side
9 Anode, negative electrode
10 Copper substrate
11 Silicon
12 Copper silicide, metal silicide
13 Rapid thermal annealing, e.g. flash lamp annealing
14 Adhesion layer
15 Multistratum structure
16 Protective layer or SEI
17 Plasma precleaning
18 Oxidation layer
19 Diffusion barrier
20 Repeated deposition of strata
21 Further metal layer, e.g. Cu or Al
22 Mixed layer
23 Dendrites
24 Nanoparticles, nanodroplets
25 Heterogeneous layer
26 Sputtering source
27 Material 1
28 Material 2
29 Mixed target composed of M1+M2
30 Partially reacted layer (e.g. Cu/CuSiₓ/Si)
31 Deposited stratum in the active layer

1. A silicon electrode designed and intended for use as anode in a lithium-ion battery, comprising a current collector (10), preferably composed of copper, an adhesion layer (14) arranged on the current collector (10), and a multistratum structure (15) arranged on the adhesion layer (14), characterized in that the multistratum structure (15) as active layer of the Si electrode is formed from at least one stratum (31) composed of a metal (21) and silicon (11) or is formed from a mixed system (22) consisting of silicon (11) admixed with at least one metal (21), the adhesion layer (14) and the multistratum structure (15) being subjected to rapid thermal annealing (13) and the multistratum structure (15) forming a conductive metal silicide matrix, the metal silicide matrix enclosing amorphous, nanocrystalline regions of silicon (11).

2. The silicon electrode designed and intended for use as anode in a lithium-ion battery as claimed in claim 1, characterized in that the adhesion layer (14) is formed from at least one of the materials titanium, Ti, silicon, Si, chromium, CR, tantalum, Ta, and/or tungsten, W.

3. The silicon electrode designed and intended for use as anode in a lithium-ion battery as claimed in claim 1, characterized in that on the multistratum structure (15) is arranged a further layer composed of silicon (11) or the mixed system (22) and/or a protective layer (16) that has a planar surface.

4. The silicon electrode designed and intended for use as anode in a lithium-ion battery as claimed in any of the preceding claims, characterized in that on the planar surface of the multistratum structure (15) is arranged a boundary layer and/or a solid electrolyte.

5. The silicon electrode designed and intended for use as anode in a lithium-ion battery as claimed in any of the preceding claims, characterized in that the multistratum structure (15) as active layer has an active layer thickness of 10 μm.

6. The silicon electrode designed and intended for use as anode in a lithium-ion battery as claimed in any of the preceding claims, characterized in that the multistratum structure (15) has a specific capacity of >1500 mAh/g, preferably >2000 mAh/g.

7. The silicon electrode designed and intended for use as anode in a lithium-ion battery as claimed in any of the preceding claims, characterized in that the multistratum structure (15) has an areal capacity of 2 mAh/cm² to 6 mAh/cm².

8. The silicon electrode designed and intended for use as anode in a lithium-ion battery as claimed in any of the preceding claims, characterized in that the multistratum structure (10) as active layer of the electrode is producible by deposition of separate strata (31) of the silicon (11) and of the at least one metal (21) in an alternating manner into multistrata.

9. The silicon electrode designed and intended for use as anode in a lithium-ion battery as claimed in any of the preceding claims, characterized in that the metal (21) provided in the active layer is formed from at least one of the materials manganese, Mn, iron, Fe, titanium, Ti, nickel, Ni, aluminum, Al, tin, Sn, gold, Au, and/or silver, Ag, and/or a mixture of said materials.

10. The silicon electrode designed and intended for use as anode in a lithium-ion battery as claimed in any of the preceding claims, characterized in that the rapid thermal annealing (13) is a flash lamp annealing and is performable by means of a flash lamp with a flash time in the range from 0.2 to 20 ms and an energy density in the range from 0.3 to 160 J/cm² and/or preheating or cooling in the range from 4° C. to 200° C.

11. The silicon electrode designed and intended for use as anode in a lithium-ion battery as claimed in any of the preceding claims, characterized in that the rapid thermal annealing (13) is a laser annealing and is performable by means of a laser with an annealing time in the range from 0.01 to 100 ms through the setting of a scan speed of a local heating point and an energy density in the range from 0.1 to 100 J/cm² and/or with preheating or cooling in the range from 4° C. to 200° C.

12. A battery cell, more particularly a lithium-ion cell, comprising a silicon electrode as claimed in any of claims 1 to 11.

13. A battery, more particularly a lithium-ion battery, comprising at least one battery cell as claimed in claim 12.
